(19) United States
(12) Patent Application Publication
(10) Pub. No.: US 2012/0240128 A1
(43) Pub. Date: Sep. 20, 2012

(54) Memory Access Performance Diagnosis

(75) Inventors: Thomas Alofs, Grenoble (FR); Nicolas Lafargue, Montbonnot-Saint-Martin (FR)

(73) Assignees: ST-ERICSSON SA, Plan-les-Ouates (CH); ST-ERICSSON (GRENOBLE) SAS, Grenoble (FR)

(21) Appl. No.: 13/497,342

(22) PCT Filed: Sep. 30, 2009
(86) PCT No.: PCT/IB2009/055103

§ 371 Date: Mar. 21, 2012

(51) Int. Cl. G06F 9/46

(52) U.S. Cl. 718/104

(57) ABSTRACT

There is disclosed a solution for obtaining Memory Access Performance metrics in an electronic system comprising a Data Processing Unit, DPU and a synchronous memory device external to the DPU and coupled to the DPU through a memory bus. There is used mixed software and hardware dedicated resources, wherein at least a hardware part of the dedicated resources is comprised in the memory device.

### BACKGROUND OF THE INVENTION

The present invention generally relates to Memory Access Performance diagnosis, and finds applications in the field of development and testing of electronic systems, in particular of the System-on-Chip (SoC) type.

1. Technical Field

Electronic systems are commonly built using a Data Processing Unit (DPU) and a synchronous memory device, such as SDRAM or flash memories (NOR, NAND, eMMC, OFS), which is external to the DPU. The memory device is coupled to the DPU through an external memory bus which, typically, comprises a command bus, an address bus and a data bus. Exchanges of data through the bus are synchronized by active transitions of a clock signal being part of the external memory bus.

More and more complex, often software configurable, hardware is built into the DPU to help the system to reach the targeted Memory Access Performance (MAP).

In the past, memory speeds were able to keep up with the DPU requirements. However, technology has reached the point where DPU ability to process data was accelerating faster than current memory technologies could support. Consequently, MAP is becoming a sensitive system parameter to be tuned to its best achievable value.

This raises the need for a system and a method for determining MAP metrics useable for software (S/W) development, DPU platform benchmarking, memory technology characterization, etc.

2. Related Art

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

The external memory bus is a node of choice for measuring MAP. This is because the external memory bus is considered as a system bottleneck for MAP, for the reasons stated above.

Methods for measuring MAP may use DPU internal resources such as timers, on-chip emulation hardware (such as ARM ETM™) or other hardware (H/W) resources.

However, current available methods for determining MAP have their limits. In particular, the more and more complex diagnosis H/W (and S/W) resources dedicated to MAP increases die area, power consumption and cost of the DPU.

### SUMMARY OF THE INVENTION

To address these issues, there is proposed a light, mixed S/W-H/W solution for measuring performance metrics on the data and command bus of an external, synchronous memory.

More precisely, there is proposed a method of obtaining Memory Access Performance metrics in an electronic system comprising a Data Processing Unit, DPU, and a synchronous memory device external to the DPU and coupled to the DPU through a memory bus, the method using mixed software and hardware dedicated resources, wherein at least a hardware part of said dedicated resources is comprised in the memory device.

In addition, the invention further provides for a computer-readable medium carrying one or more sequences of instructions for performing all the steps of a method as broadly defined above when executed by a processor. Additional provision is made for a computer program product comprising one or more stored sequences of instructions that are accessible to a processor and which, when executed by the processor, cause the processor to carry out the steps of a method as broadly defined above.

In another aspect, there is proposed a synchronous memory device adapted for use in an electronic system comprising a Data Processing Unit, DPU, and the synchronous memory device external to the DPU and coupled to the DPU through a memory bus, the memory device comprising at least an embedded hardware part of mixed software and hardware resources dedicated to obtaining Memory Access Performance metrics in the system.

In yet another aspect, provision is made for a system comprising a Data Processing Unit, DPU, and a synchronous memory device, external to the DPU and coupled to the DPU through a memory bus, as broadly define above.

The DPU may comprise at least a software part of the resources dedicated to obtaining Memory Access Performance metrics, said software part being adapted for controlling the hardware part of said dedicated resources to obtain the Memory Access Performance metrics through the memory bus.

Finally, the invention also concerns a wireless communication device comprising a system as broadly defined above. Such wireless communication devices may be, while not being limited to, for instance, mobile telephones, personal data appliances, personal digitals assistants (PDAs), lap top computers and the like.

The fundamental feature of the above solution is to have the H/W part of the dedicated resources built into the memory device rather than into the DPU. Only a light S/W part of the dedicated resources remains on the DPU side, and will manage memory H/W configuration and read-out for calculation of performance metrics once the diagnosis procedure is finished.

As a consequence, there is no need for dedicated, complex diagnosis H/W (and S/W) in the DPU. The reservation of DPU internal H/W resources unavailable for application on the DPU side is thus avoided.

The modification of the H/W architecture of the memory device, compared with a conventional memory device, is simple and involves negligible (memory) die area and power consumption increase.

Embodiments of the invention also make performance measurement process independent of the DPU hardware, thus providing a generic solution applicable on any kind of synchronous memory. The method has therefore the potential to become a standard method to be used across large variety of DPU platforms based on all kinds of external synchronous memories.

It provides reliable metrics for the purposed use above mentioned, including software development and memory technology characterization. In particular, MAP measurement is more precise than with conventional methods, because there is no SAN and cycle overhead in the running application for start/stop timers, etc.

### BRIEF DESCRIPTION OF THE DRAWINGS

The invention is illustrated by way of example, and not by way of limitation, in the figures of the accompanying drawings in which like reference numerals refer to similar elements, and in which:

FIG. 1 shows diagrammatically the general architecture of a system according to embodiments;

FIG. 2 is a flow chart illustrating an exemplary Sequence state machine of the system;

FIG. 3 is a flow chart illustrating an exemplary Occurrence Metric state machine of the system;

FIG. 4 is a flow chart illustrating an exemplary Duration Metric state machine of the system;

FIG. 5 is a flow chart illustrating an exemplary State-Counter Metric state machine of the system;

FIG. 6 is a flow chart illustrating an exemplary Control state machine of the system;

FIG. 7 is a timing diagram which illustrates operation of the system with a maximum of three parallel running diagnosis tasks;

FIG. 8 is a schematic diagram of the memory H/W architecture of the system;

FIG. 9 is a schematic diagram of a set of event detectors;

FIG. 10 is a schematic diagram of a set of sequence detectors;

FIG. 11 is a schematic diagram of a task manager;

FIG. 12 is a schematic diagram of a set of metric calculators;

FIG. 13 is a block diagram illustrating steps of a method of MAP diagnosis; and,

FIG. 14 is a schematic diagram of an apparatus comprising an electronic system embodying the solution proposed herein.

### DESCRIPTION OF EMBODIMENTS

In the following description of embodiments, expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa, unless specifically indicated otherwise in the description of the embodiments.

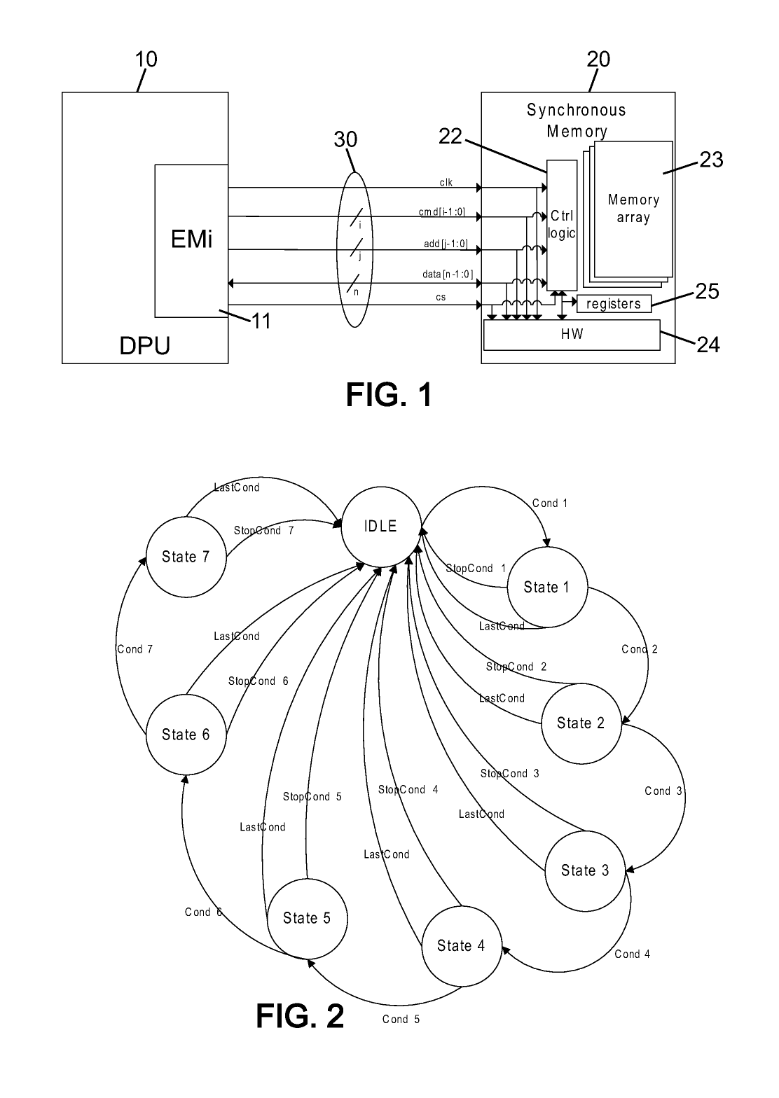

With reference to FIG. 1, an electronic system embodying the present solution comprises a Digital Processing Unit 10, also referred to as a DPU in what follows. In the context of the present description, the acronym DPU shall be used as an abbreviation to any type of Central Processing Unit (CPU) like a microprocessor or a microcontroller, of Direct Memory Access controller (DMA), of SoC, of Application Specific Integrated Circuit (ASIC), etc.

The system further comprises a synchronous memory device 20, such as, for instance, SDRAM (SDR, DDR, LP-DDR . . . ), flash memories (NOR, NAND, eMMC, OFS . . . ), muxed NOR, Toggle mode DDR-NAND, managed NAND (e.g., Samsung's oneNand™), etc. The memory device 20 is external to the unit 10.

Unit 10 and memory device 20 are coupled one to the other through an external memory access bus 30, via respective External Memory Interface (EMI) modules 11 and 21, respectively. The access bus is of the synchronous type. A reference clock is used for the purpose of synchronizing signals exchanged there through.

The external memory bus 30 comprises a set of signals, depending on the class of memory. As shown in FIG. 1, there might be a command bus (having a number i of lines cmd[i-1:0]) and/or an address bus (having a number j of lines add[j-1:0]) and/or a data bus (having a number n of lines data[n-1:0]), in addition to a line for transmitting the clock signal (clk) to the memory device 20 and a line for transmitting a Chip Select (cs) signal which, when activated, selects the memory device for allowing a write and/or read access to be executed.

The memory device 20 comprises a control logic 22 for decoding signals received through the bus 30 and control execution of the requested access within the memory array 23.

The external memory bus 30 is also a node of choice for measuring MAP, as mentioned in the introduction of the present description.

Therefore, for the purpose of memory access performance diagnosis, and according to embodiments of the invention described herein, the memory device 20 comprises dedicated hardware resources 24. Stated otherwise, hardware resources 24 are dedicated to the function of performance diagnosis with respect to the memory device 20. This hardware part 24 of the performance diagnosis resources is configured to, under control of a software part of the dedicated diagnosis resources which might advantageously be loaded and run in the DPU, observe signals of the bus 20 at each active transition of the memory clock.

The binary pattern consisting of given bit values for a pre-defined set of signals defines what is called an Event. These signals can be either memory bus signals or memory internal signals. An Event lasts one memory cycle. The signals that are used to define an Event depend on the memory type.

In what follows, it shall first be given some basics about how MAP diagnosis is carried out in the concerned field of technology. Not all the information contained in the description below and in the corresponding figures of the drawings is to be regarded as necessary for describing the embodiments, but it is considered to be useful for the reader to get understanding of the architecture of the system and of relevant steps of the method at stake.

In particular, the following table represents how Events can be defined with respect to memory bus signals and memory internal signals:

TABLE 1

| | Pattern | | | | | | | |
|---|---|---|---|---|---|---|---|---|
| Event | Memory Bus Signal Name | | | | Memory Internal Signal Name | | | |
| Name | bus sig 1 | bus sig 2 | . . . | bus sig n | int sig 1 | int sig 2 | . . . | int sig m |
| Event 1 | 0 | 0 | | Don't care | 0 | 0 | | Don't care |
| Event 2 | 0 | Don't care | | 0 | 0 | 1 | | 0 |
| Event 3 | 1 | Don't care | | 1 | 1 | Don't care | | 1 |
| . . . | | | | | | | | |
| Event i | Don't care | 0 | | 0 | Don't care | 0 | | Don't care |

A group of, for instance, 2 to 8 events forms what is called a diagnosis Sequence. A Sequence follows a Finite State Machine as illustrated in FIG. 2 in one example wherein there are 7 different states (from “State 1” to “State 7”) in addition to the idle state, all of which being represented by circles. The arrows linking circles represent conditions for the change from one state to another state. In this generic state machine, each of the conditions referred to as “Cond X” (X being an index ranking from 1 to 7 in this example), “StopCond X” and “LastCond” corresponds to a specific Event. When a condition “Cond X” is satisfied, the Sequence FSM jumps from sate X-1 to state X. The Sequence is held valid when the condition “LastCond” is verified, and the Sequence FSM then returns to the idle state. Whatever state X at a given instant, when the condition “StopCond X” is verified the Sequence is broken and the Sequence FSM also returns to idle.

A Sequence is thus defined by its length (number of Events that compose the Sequence), the Events themselves (Cond X, LastCond) and some other Events that may break the sequence (StopCond X). Table 2 below provides a generic illustration of how a number k of diagnosis Sequences may be defined for the system.

TABLE 2

| Sequence | Events | | | | | | | | |
|---|---|---|---|---|---|---|---|---|---|
| Name | Number | Cond 1 | Cond 2 | Cond 3 | Cond 4 | Cond 5 | Cond 6 | Cond 7 | . . . |
| Sequence 1 | 2 | Event 1 | N/A | N/A | N/A | N/A | N/A | N/A | . . . |
| Sequence 2 | 2 | Event 2 | N/A | N/A | N/A | N/A | N/A | N/A | . . . |
| Sequence 3 | 3 | Event 3 | Event 2 | N/A | N/A | N/A | N/A | N/A | . . . |
| Sequence 4 | 4 | Event 2 | Event 3 | Event 4 | N/A | N/A | N/A | N/A | . . . |
| Sequence 5 | 7 | Event 2 | Event 3 | Event 4 | Event 1 | Event 1 | Event 1 | N/A | . . . |
| . . . | . . . | . . . | . . . | . . . | . . . | . . . | . . . | . . . | . . . |
| Sequence k | 8 | Event 4 | Event 3 | Event 1 | Event 2 | Event 1 | Event 1 | Event 1 | . . . |

| Sequence | | Stop | Stop | Stop | Stop | Stop | Stop | Stop | Last |
|---|---|---|---|---|---|---|---|---|---|
| Name | . . . | Cond 1 | Cond 2 | Cond 3 | Cond 4 | Cond 5 | Cond 6 | Cond 7 | Cond |
| Sequence 1 | . . . | Event 3 | N/A | N/A | N/A | N/A | N/A | N/A | Event 1 |
| Sequence 2 | . . . | Event 3 | N/A | N/A | N/A | N/A | N/A | N/A | Event 4 |
| Sequence 3 | . . . | Event 2 | Event 1 | N/A | N/A | N/A | N/A | N/A | Event 3 |
| Sequence 4 | . . . | Event 1 | Event 1 | Event 1 | N/A | N/A | N/A | N/A | Event 2 |
| Sequence 5 | . . . | Event 5 | Event 1 | Event 5 | Event 6 | Event 5 | Event 5 | N/A | Event 2 |
| . . . | . . . | . . . | . . . | . . . | . . . | . . . | . . . | . . . | . . . |
| Sequence k | . . . | Event 1 | Event 1 | Event 5 | Event 6 | Event 4 | Event 4 | Event 4 | Event 1 |

Advantageously, Events and Sequences can be defined by S/W through dedicated registers among a bank of registers 25 in the memory device 20. At least some of the registers 25 belong to the dedicated H/W resources of memory device 20 which are specifically provided for performance diagnosis.

Events and Sequences are used for the MAP diagnosis to control the diagnosis window (start, stop) and the metrics that need to be measured.

It shall now be presented the performance metrics that dedicated H/W is able to calculate. Their definition is programmable and their value is observable by S/W when the diagnosis ends. In embodiments described herein, a diagnosis metric is composed of 3 fields. Also, a metric can be of type “Occurrence”, “Duration” or “StateCounter” and its fields are either an Event or a Sequence. It should be understood, however, that the invention is not intended to be limited by specific number of fields, types or names used for the metrics described herein.

The generic definition of diagnosis metrics can be represented by the following table 3:

TABLE 3

| Metrics Name | Type | Field 1 | Field 2 | Field 3 |
|---|---|---|---|---|
| Metric 1 | Occurrence | Event 2 | N/A | N/A |
| Metric 2 | Duration | Sequence 1 | Event 1 | N/A |
| Metric 3 | Duration | Event 3 | Event 2 | N/A |

. . .

| | | | | |
|---|---|---|---|---|
| Metric k | StateCounter | Event 3 | Sequence 1 | Sequence 1 |

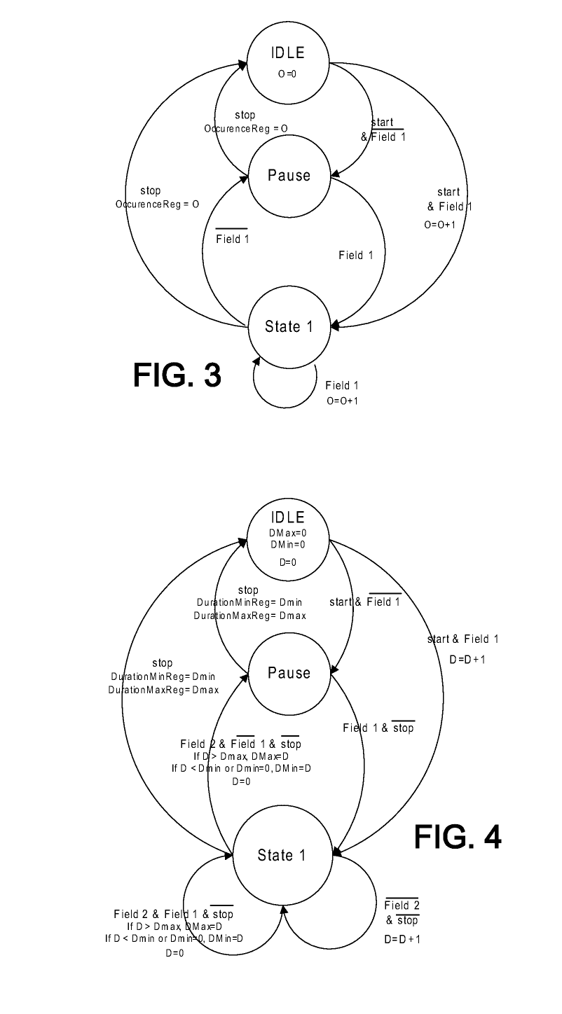

If the type of a metric is “Occurrence”, the second and third fields are not used: the metric consists in counting the occurrence of the Event or Sequence specified in the first field. It gives the number of times that the State 1 of a finite state machine associated with this metrics has been entered. FIG. 3 illustrates such Occurrence Metric state machine. In the text inserted in this figure, letter “o” refers to the current value of an occurrence counter. An example of metric of the Occurrence type may be a metric for measuring the bandwidth of the memory device. Memory bandwidth is basically defined by the number of effective data read/write accesses over a period of time. Thus, there is counted the number of read/write accesses occurring between Start and Stop Events.

If the type is “Duration”, the third field is not used: the metric is measuring the minimum and the maximum interval of time (in memory cycles) between the two Events (or Sequences) specified in the first and second fields, respectively. FIG. 4 illustrates such Duration Metric state machine. In the text inserted in this figure, letter “D” refers to the current value of a duration counter, and “Dmin” and “Dmax” respectively refer to applicable values of parameters “DurationMin” and “DurationMax”, respectively, which define limits for actual duration of the a.m. interval of time.

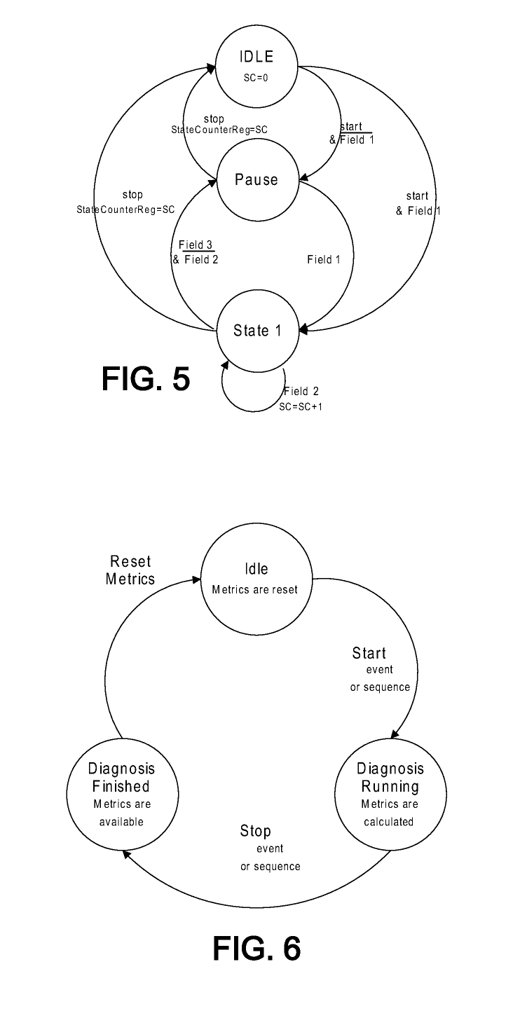

If the type is “StateCounter”, the metric indicates the number of cycles that state 1 of the FSM described below has been entered. FIG. 5 illustrates such

StateCounter Metric state machine. In the text inserted in this figure, letters “SC” refer to the current value of a state counter.

With reference to Table 4 below, a diagnosis task may be defined by:
a start condition which indicates when the diagnosis must start;
a stop condition which indicates when the diagnosis must stop; and,
one to e.g. four Metrics (A,B,C,D) that are the performance parameters measured during the diagnosis.

TABLE 4

| DiaX Task | | | Diax | Diax | Diax | Diax |
|---|---|---|---|---|---|---|
| Name | Start | Stop | Metric A | Metric B | Metric C | Metric D |
| DiaX Task 1 | Event 1 | Event 2 | Metric 1 | none | none | none |
| DiaX Task 2 | Event 1 | Sequence 2 | Metric 1 | Metric 2 | Metric 3 | Metric 4 |
| DiaX Task 3 | Sequence 1 | Sequence 3 | Metric 2 | Metric 3 | none | none |
| . . . | | | | | | |
| DiaX Task I | Sequence 4 | Event 3 | Metric 2 | Metric 3 | Metric 4 | none |

The state machine illustrated by FIG. 6 describes how the start and stop conditions define the diagnosis window.

Monitoring dynamically a performance metric can be easily done by defining several consecutive tasks (start condition of Task N=stop condition of Task N-1), each task containing the metric to be measured.

A counter measuring the duration of a task is associated to every task. The value of this counter is accessible by S/W when the diagnosis is finished.

More generally, the diagnosis results, which are stored in the registers 25, may be read by the DPU through the memory access bus 30 as is already the case for data stored in existing configuration registers of currently available memory devices. This shall be explained in more details below.

The Class of a system, with respect to MAP diagnosis, represents the quantity of embedded H/W available for diagnosis. In the context of the present description, it indicates the numbers of Events, Sequences, Tasks and Metrics which are supported by H/W resources embedded into the memory device. The information represented by the class of a memory device, when indicated into system requirements, allows the memory manufacturer to choose the appropriated level of hardware resources dedicated to diagnosis.

A diagnosis class may be expressed in the following form: ExSyTzOsDtCu where:
x is the maximum number of Events that can be defined;
y is the maximum number of Sequences that can be defined;
z is the maximum number of Tasks that can run in parallel during a diagnosis;
s is the maximum number of Metrics that can have the “Occurrence” type;
t is the maximum number of Metrics that can have the “Duration” type; and,
u is the maximum number of Metrics that can have the “StateCounter” type.

In one embodiment, the diagnosis class is information which is accessible by the user through a dedicated internal register, among those of the bank of registers 25 (FIG. 1).

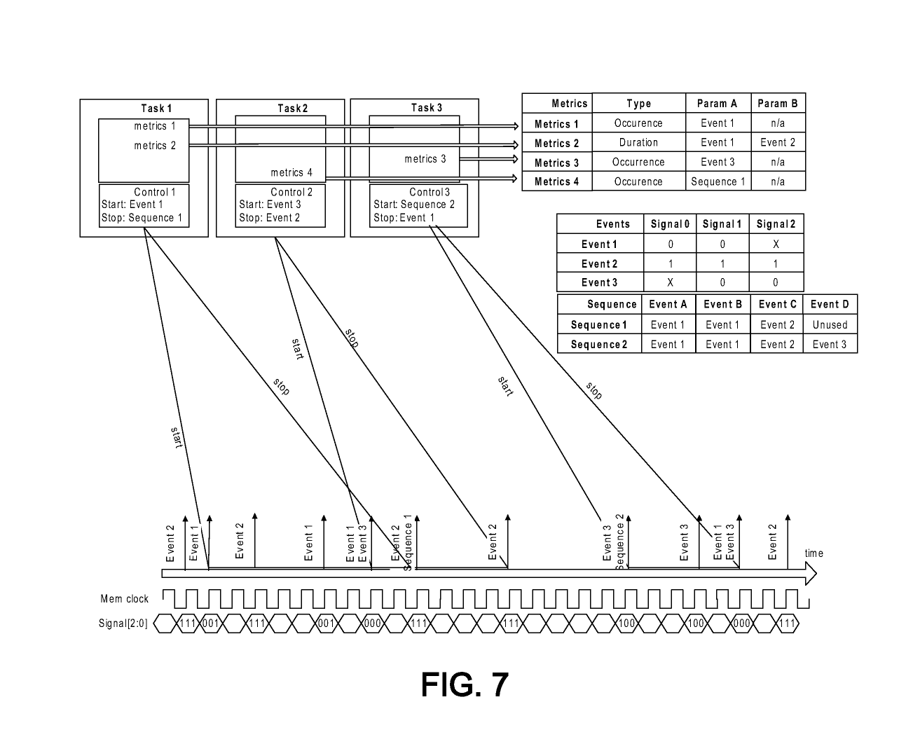

The timing diagram represented at the bottom of FIG. 7 illustrates the diagnosis windows respectively associated to three diagnosis Tasks (“Task1”, “Task2”, and “Task3”), in one example of a system having a diagnosis class which expresses as: E3S2T3O3D1C0.

Along the horizontal time line, vertical arrows indicate times of occurrence of Events and/or time of completion of Sequences. The memory clock signal and the observed signals (“Signal 0”, “Signal 1” and “Signal 2”) are represented under said time line.

Definition of the diagnosis windows is given by the start condition and the stop condition which are indicated in the table at the top, left side, of FIG. 7. This table is similar to Table 4 above, and contains information defining the diagnosis Tasks.

Three other tables represented at the top, right side, of FIG. 7, contain information defining the Events, Sequences and Metrics for the system, and have the structure of above Table 1, Table 2 and Table 3, respectively.

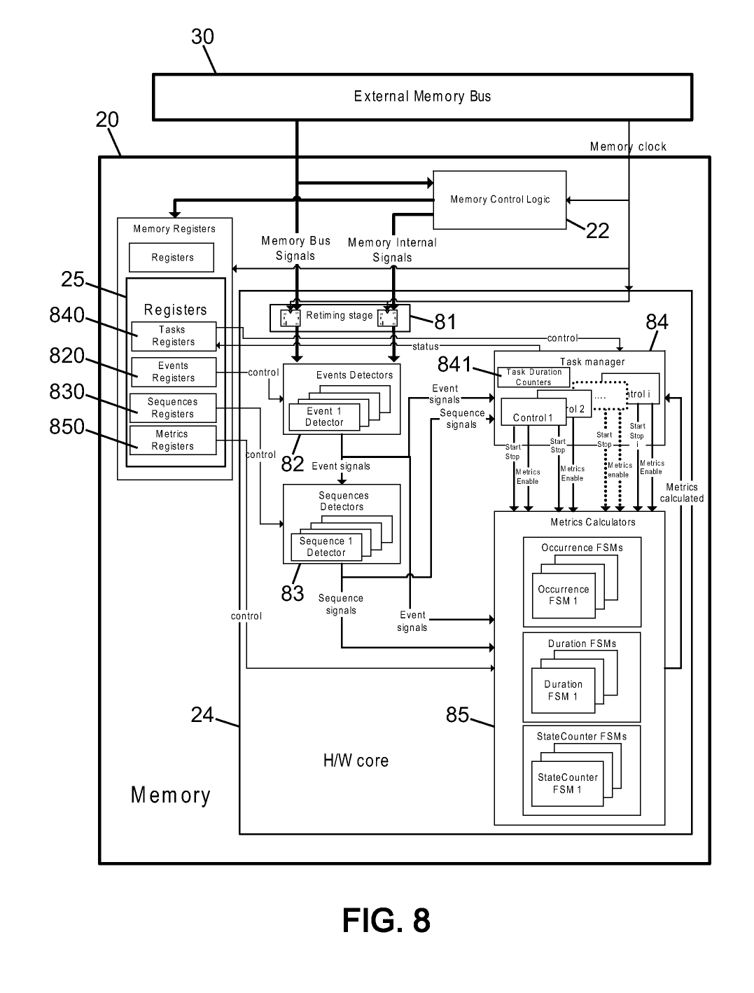

With reference to FIG. 8, it shall now be described an example of architecture of the hardware resources of the memory device which are dedicated to performance diagnosis. These resources, which are internal to the memory device 20 comprise a set 25 of specific registers and a H/W core 24 including all the required hardware needed to detect the diagnosis events and sequences, manage the diagnosis tasks and calculate the diagnosis metrics. Registers of the set of registers 25 are configurable in the same way as existing configuration registers which are commonly comprised in memory registers of a standard memory.

The following paragraphs shall first provide a detailed description of the different blocks included inside the H/W core 24. For the purpose of this description, it is assumed by way of example only, that the number of bits required to encode an event or a sequence is 5 (i.e. the number of events that can be defined will not exceed 31, same for the number of sequences . . . ).

The core 24 may first comprise a retiming stage 81 which might be useful in embodiments wherein the synchronous memory is of the pipelined type (typically SDRAM memories). This stage receives each memory bus signal and each memory internal signal that is used to define an event. It has the function to sample these signals on the active edge of the memory clock signal Clk, and to provide its sampled values to a set 82 of event detectors.

The event detectors 82 are composed of combinational logic only, and are clocked by the memory clock signal Clk.

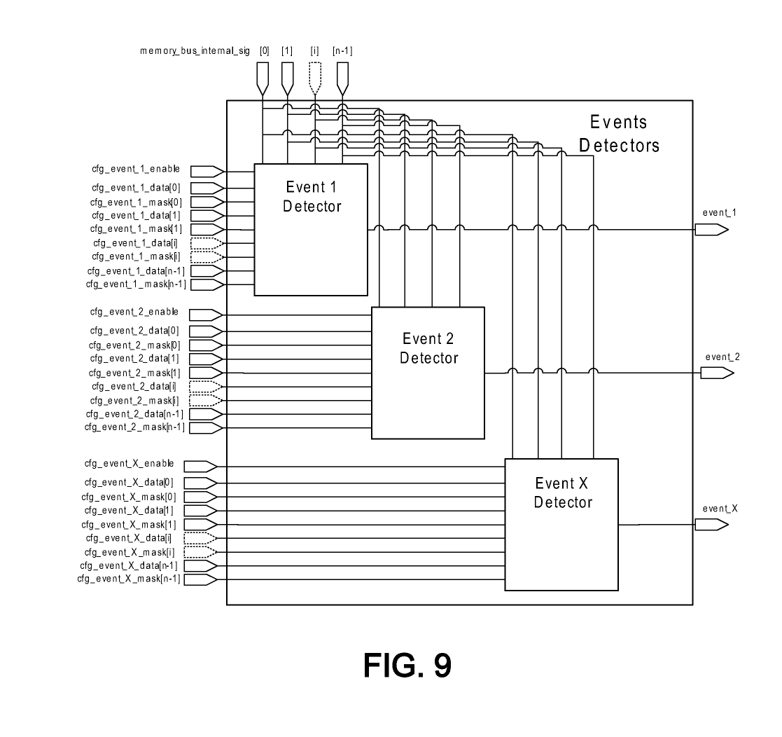

FIG. 9 shows the signals received and generated by the event detectors. Each of the event detectors is configured to detect a specific event. To this end, it monitors at least some of the memory bus signals and of the memory internal signals. These incoming signals are represented vertically on the top of FIG. 9, and are named “memory_bus_internal_sig [i], where i is an index ranking from 0 to n-1, with n being the total number of memory bus signal and of internal signals.

Each of the event detectors generates one pulse on a signal named “Event_X” in FIG. 9, with X being an index ranking from 1 to x, the maximum number of Events, each time it sees the corresponding pattern on the observed memory signals. These outputted signals are represented horizontally on the right side of FIG. 9.

Depending on the desired configuration of the Event Detectors, observation of some of the memory bus signals and/or of the memory internal signals may be selectively disabled by use of, for instance, programmable masks or by any other masking technique.

For instance several configuration registers 820, contained in the bank of registers 25, may be used to define the event detectors in a programmable way. These configuration registers 820 generate the following signals, where X is the index mentioned above, which are inputted to the event detectors:
cfg_event_X_enable: these signals are used to enable or disable the detector. When low, the detector is disabled, the Event_X signal is not active (low). When high, the detector is running;
cfg_event_X_data[n-1:0] and cfg_event_X_mask[n-1:0]: these signals are used to define the event in a programmable way. When cfg_event_X_mask[i] is high, the bit i of the memory bus is “don't care”, when cfg_event_X_mask[i] is low, the bit i of the memory bus is used for comparison with cfg_event_X_data[i]. The event is detected when every bit n of the memory bus (internal signal or external bus), where cfg_event_X_mask[n]=0, matches cfg_event_X_data[n].

The above incoming signals are represented horizontally on the left side of FIG. 9.

Back to FIG. 8, the H/W core 24 of the dedicated hardware resources further comprises a set of sequence detectors 83. These sequence detectors indicate that a sequence has occurred by generating one pulse on the corresponding signal “Seq_Y”, where Y is an index ranking from 1 to y, the maximum number of sequences that can be defined as explained above.

Each sequence detector may include a generic Sequence Finite State Machine (FSM), the generic description of which has already been given above with reference to FIG. 2, controlled by some dedicated configuration registers 830 of the set of registers 25. These configuration registers 830 generate, for each of the sequence detectors, configuration signals called by names having the following format: “cfg_seq_xxxx”, i.e., the prefix “cfg_seq”, which are input to the FSM as configuration signals.

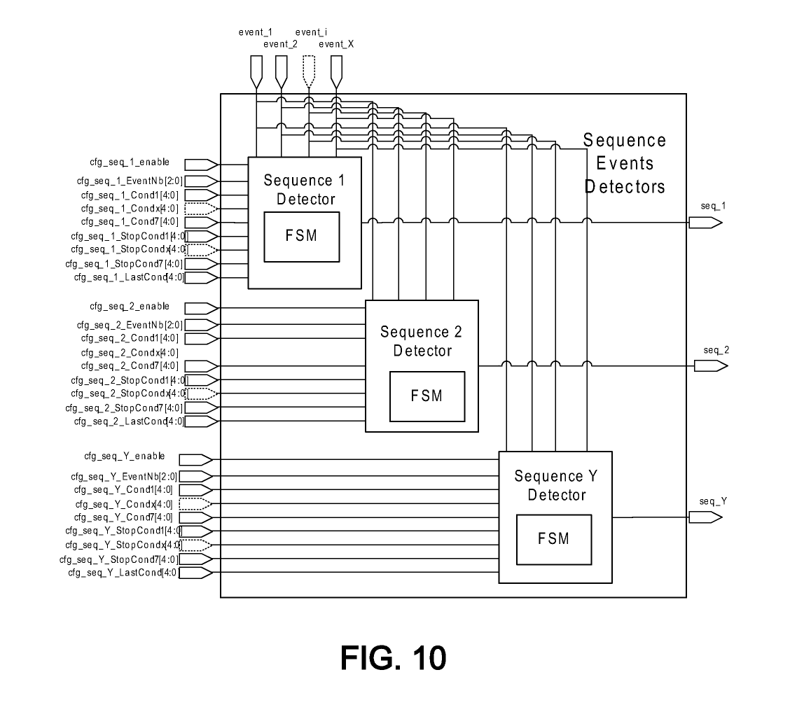

The input and output signals of the various sequence FSM appear in FIG. 10, which gives the definition of the sequence detectors. In this figure, the input signals Event_X are represented vertically at the top, the output signals Seq_Y are represented horizontally on the right, and the configuration signals cfg_seq_xxxx are represented horizontally on the left. The latter include the following signals (where Y is the index defined above):
cfg_seq_Y enable: this signal is used to enable or disable the detector. When low, the detector is disabled, the seq_Y signal is not active (low). When high, the detector is running;
cfg_seq_Y_EventNb[2:0]: these signals indicate the number of events (which, in one example, can be 1 up to 7 in addition to the IDLE state) used to define the sequence, and allow to choose amongst the different states of the FSM: “0x0” is reserved, “0x1” means 1 state, “0x7” means 7 states, etc.;
cfg_seq_Y_Condx[4:0] with x from 1 to 7: these signals each define the event that enables the corresponding FSM to go into the state x. “cfg_seq_Y_Cond1[4:0]=0x02” means that event_{—}2 is the condition to go from state IDLE to state 1. “cfg_seq_Y_Condx” is ignored when cfg_seq_Y_EventNb<x;
cfg_seq_Y_StopCondx[4:0] with x from 1 to 7: these signals stop the corresponding sequence on an event. They define the event that enables the FSM to go from the state x to the state IDLE. “cfg_seq_Y_Stop1[4:0]=0x02” means that event 2 is the condition to go from state 1 to state IDLE. “cfg_seq_Y_Stopx” is ignored when cfg_seq_Y_EventNb<x;

cfg_seq_Y_LastCond[4:0]: these signals define the last event of the corresponding sequence. When the FSM is in the state number “cfg_seq_Y_EventNb[2:0]”, “cfg_seq_Y_LastCond” represents the missing event to complete the sequence. If FSM is in state “cfg_seq_Y_EventNb[2:0]” and condition “cfg_seq_Y_LastCond” occurs, a pulse is generated on the signal seq_Y.

The H/W core 24 of the device further comprises a task manager 84, which includes the H/W needed to define all the tasks that are run during the diagnosis.

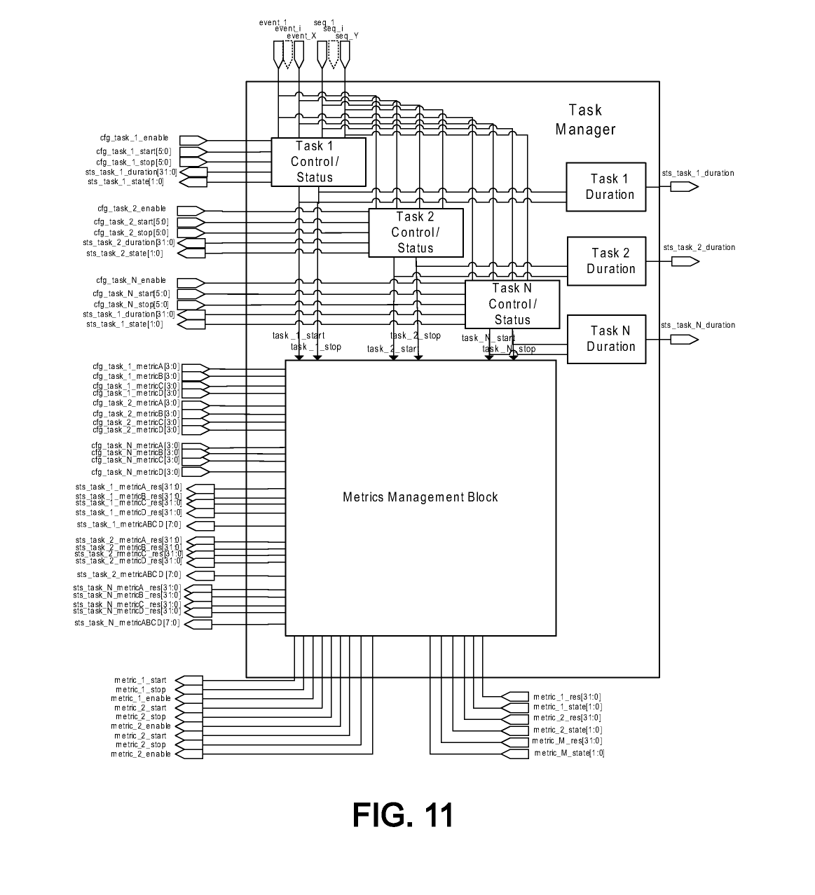

The task manager 84 includes z task control/status blocks, z being the maximum number of tasks that can be run in parallel, one metric management block and one Task Status block. Each of theses blocks or group of blocks will be now briefly detailed, with reference to FIG. 11.

The task control/status blocks are used to define the task and provide information of it. They generate the start and stop signals for every task. These signals are transmitted to the metrics thanks to the metrics management block. They are used by the task duration counters 841

A task control/status block Z, where Z is an index ranking from 1 to z, is configured through tasks registers 840 of the set 25 of diagnosis configuration registers. In one example, there are 3 such tasks registers which generate the following configuration signals:
cfg_task_Z_enable: this signal is used to enable or disable a task. When low, the task Z is OFF, when high, the task is ON;
cfg_task_Z_start[5:0]: this signal defines the starting condition of the diagnosis window. It is valid when cfg_task_Z_enable=1. Bit 5 indicates if it is an event or a sequence (0 for event, 1 for sequence). Bits [4:0] indicate what event or sequence is chosen to start the task (cfg_task_Z_start [4:0]=0x00 is reserved); and,
cfg_task_Z_stop[5:0]: this signal defines the stopping condition of the diagnosis window. Valid when cfg_task_Z_enable=1. Bit 5 indicates if it is an event or a sequence (0 for event, 1 for sequence). Bits [4:0] indicate what event or sequence is chosen to stop the task (cfg_task_Z_stop [4:0]=0x00 is reserved).

For example, if “cfg_task_Z_start[5:0]=0x12” and “cfg_task_Z_stop[5:0]=0x01”, it means that the task Z will start on the event number 1 (event 1) and stop on the sequence number 2 (seq_{—}2).

The control/status blocks are also used to indicate the state of the task through the following bus: sts_task_Z_state[1:0], wherein
‘00’ means that task Z is not active (at reset or when CFG_TASK_Z_ENABLE=0);
‘01’ means that task Z has started and is running (not stopped);
‘10’ means that task Z is not active but has not started (the starting condition has not occurred); and,
‘11’ means that task Z is finished.

Let us now consider the metric management block of the task manager 84.

This block is in charge of launching and stopping the metrics used in the different active tasks.

It receives the start and stop signals from the task control blocks and send them to the right metrics according to what the user has defined in its configuration registers. It also sends back the results of the metrics to the status registers when the task is finished.

Its main inputs are:
cfg_task_Z_metricA[3:0];
cfg_task_Z_metricB[3:0];
cfg_task_Z_metricC[3:0]; and,
cfg_task_Z_metricD[3:0].

These configuration registers are used to select what metric must run during the task Z (it is considered in this example that there is 4 metrics at maximum: metricA, metricB, metricC, metricD).

For instance, “cfg_task_Z_metricM[3:0]=0x00” indicates that the metric M is not used. Otherwise it indicates the number of the metric that must run.

The outputs of the metric management block are:
sts_metric_i_res[31:0]: Status register containing the result of the metric i. It can be an occurrence or a duration, depending on the type of this metric;
sts_metric_i_state[1:0]: Status register indicating the state of the metric i:
   sts_metric_i_state[1:0]=00: sts_metric_i_res[31:0] is not valid;
   sts_metric_i_state[1:0]=01: sts_metric_i_res[31:0] is valid but not final, the metric is still running; and,
   sts_metric_i_state[1:0]=11: sts_metric_i_res[31:0] is valid and final, the metric has finished to run; and,
metric_i_enable, metric_i_start, metric_i_stop: output signals to control the metric calculators.

It shall be noted that, on a soft reset, sts_metric_i_state[1:0]=00.

Finally, let us end with the task status block of the task manager 84.

This block gives status information of every task. Two kinds of information are provided: the task duration and the task state.

In order to inform the user of the task duration, the task status block includes N task duration counters that calculate the duration of a task by counting the number of memory cycles between the start and the stop conditions of this task. The duration of every task is then available through sts_task_Z_duration[31:0] registers. These counters are reset via a soft reset.

The state of every task is also available through the sts_task_Z_state[1:0] registers:
sts_task_Z_state[1:01=00: not active—when cfg_task_Z_enable=0—reset value;
sts_task_Z_state[1:01=01: task Z has started and is running;
sts_task_Z_state[1:01=10: task Z is activated but has not started—waits for the start condition to start; and
sts_task_Z_state[1:01=11: task Z is finished.

Back to FIG. 8, the H/W core 24 of the memory device 20 further comprises metrics calculators 85.

This Metrics calculators block is mainly composed of all the FSMs required to calculate the metrics. It includes FSMs of type Occurrence, Duration and StateCounters, which have already been described above in reference with FIG. 3, FIG. 4 and FIG. 5, respectively.

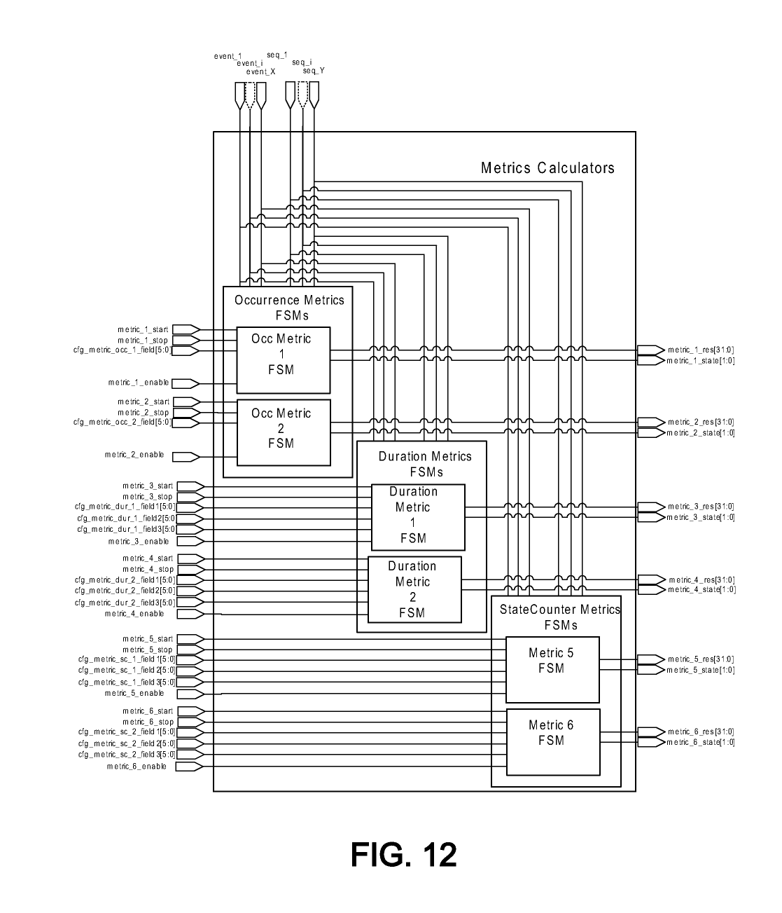

FIG. 12 illustrates the metrics calculators 85 for a device of class ExSyTzO2D2C2 (namely, a device supporting 2 metrics of each type).

One FSM referenced by letter x has the following signals:
metric_x_start, metric_x_stop: these signals come from the task manager and correspond to the start and stop conditions, respectively, of the FSM (see FIG. 3, FIG. 4 and FIG. 5);
cfg_metric_‘type’_y_field1[5:0], cfg_metric_‘type’_y_field2[5:0], cfg_metric_‘type’_y_field3[5:0]: these signals are controlled by software and allow the user to define the events and sequences corresponding to the fields 1, 2 and 3 of the metrics (see FIG. 3, FIG. 4 and FIG. 5). ‘type’ represents the type of the metric, i.e., it can be either “occ” or “dur” or “sc”, for Occurrence metrics, Duration metrics and StateCounter metrics, respectively. [It shall be noted that if metric x is of type Occurrence, then cfg_metric_x_field2[5:0] and cfg_metric_x_field3[5:0] do not exist.
metric_x_enable: this signal is generated by the Metrics management block. When ‘0’, the FSM is not running whatever the metric_x_start signal is. When ‘1’ the FSM can run.
event_i and seq_j: these signals indicate that an event and/or a sequence is occurring. They are needed to determine the FSM transitions.
metric_x_state[1:0] : this output is sent to the Task Manager to inform of the FSM state. It corresponds to sts_metric_i_state of the “Metrics Management block”.
metric_x_res[31:0]: this output is the metric result.

If the type of the metric is Occurrence, it represents the parameter O which is calculated by the FSM and appearing in FIG. 3.

If the type of the metric is Duration, it represents the metric D which is calculated by the FSM and appearing in FIG. 4.

If the type of the metric is Occurrence, it represents the metric SC which is calculated by the FSM and appears in FIG. 5.

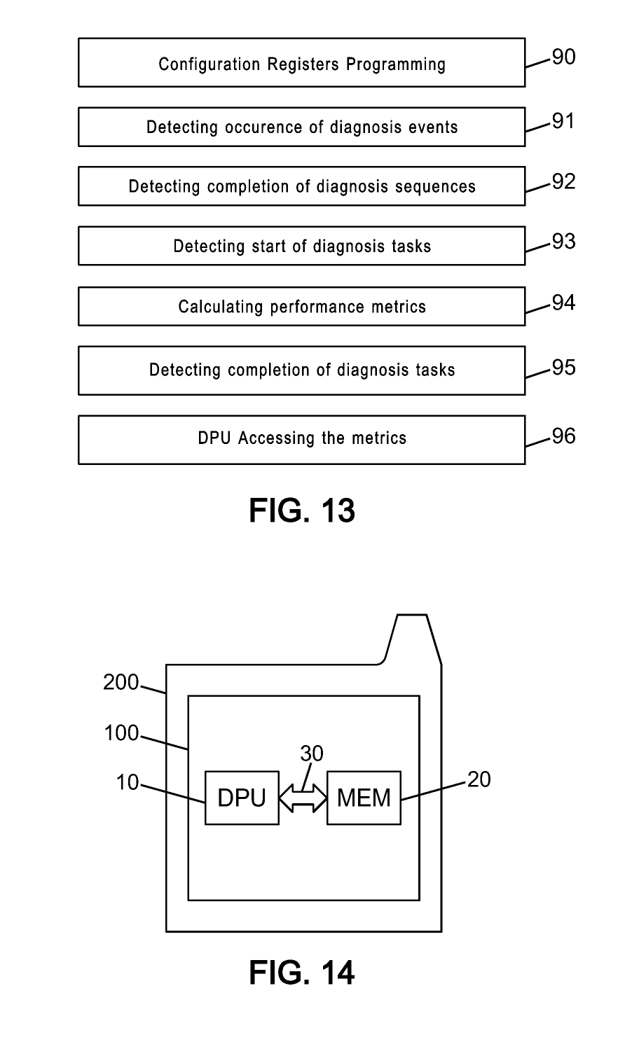

The block diagram of FIG. 13 illustrates the main steps of a method of obtaining MAP metrics in an electronic system such as described above. The method may thus comprise, while not being limited to the following steps;

Step 90: programming the configuration registers, for adapting the definition of the events, sequences, and/or tasks of the system;

Step 91: detecting occurrence of diagnosis events by observing the memory bus signals and, such being the case detecting the start condition of a diagnosis task;

Step 92: detecting completion of diagnosis sequences;

Step 93: detecting start of diagnosis tasks (start condition);

Step 94: calculating performance metrics

Step 95: detecting completion of diagnosis tasks (stop condition) when all their metrics are calculated; and,

Step 96: accessing to the metrics by the DPU through read access to the corresponding registers of the H/W resources.

As it will be understood by the one with ordinary skills in the art, the order of the steps of the method may not be limited to the order adopted for their above description. Also, steps of the method may be interleaved one with others.

In FIG. 14, there is shown diagrammatically an apparatus 200 comprising an electronic system 100 as broadly described with reference to FIG. 1 and detailed herein above.

The implementation of embodiments is compatible with existing diagnosis modes, such as, for instance, those defined as Debug Host Control Mode (DHCM) and Application Memory Access Mode (AMAM):
DHCM is a diagnosis mode where pre-defined ‘non-functional’ information (for debug purposes) is send to the memory to start/stop diagnosis. Typically, this information can be produced by S/W breakpoints during a host debug session. Under certain conditions, this mode might be somehow imprecise since it may induce cycle overhead on the running application for enabling/disabling diagnosis. In this mode, the start and stop conditions are pre-defined diagnosis Sequences; and
AMAM is a diagnosis mode where diagnosis is started or stopped when there is a diagnosis window border address match during memory access. This method provides more accurate performance metrics since there is no cycle overhead on the running operation.

Advantageously, there is no need for dedicated, complex diagnosis H/W (and S/W) in the DPU. It avoids the reservation of internal H/W resources unavailable for application.

The H/W architecture is kept simple. Implementations require negligible memory die area, and involve negligible power consumption increase.

Metrics given may be cycle accurate, unlike imprecise methods known in of the prior art (which suffer S/W and cycle overhead in the running application for start/stop timers etc.).

There is thus provided a generic solution applicable on any kind of synchronous memory, which thus has the potential to become a standard method to be used across large variety of DPU platforms based on all kinds of external synchronous memories.

The S/W part of the system if easily adaptable to different DPU hardware platforms. There is no cycle overhead on the running application during diagnosis.

Different aspects of present solution can be implemented in hardware, software, or a combination of hardware and software. Any processor, controller, or other apparatus adapted for carrying out the functionality described herein is suitable. A typical combination of hardware and software could include a general purpose microprocessor (or controller) with a computer program that, when loaded and executed, carries out the functionality described herein.

Embodiments can also be embedded in a computer program product, which comprises all the features enabling the implementation of the methods described herein, and which—when loaded in an information processing system—is able to carry out these methods. Computer program means or computer program in the present context mean any expression, in any language, code or notation, of a set of instructions intended to cause a system having an information processing capability to perform a particular function either directly or after either or both of the following a) conversion to another language. Such a computer program can be stored on a computer or machine readable medium allowing data, instructions, messages or message packets, and other machine readable information to be read from the medium. The computer or machine readable medium may include non-volatile memory, such as ROM, Flash memory, Disk drive memory, CD-ROM, and other permanent storage. Additionally, a computer or machine readable medium may include, for example, volatile storage such as RAM, buffers, cache memory, and network circuits. Furthermore, the computer or machine readable medium may comprise computer or machine readable information in a transitory state medium such as a network link and/or a network interface, including a wired network or a wireless network, that allow a device to read such computer or machine readable information.

From the foregoing it will be appreciated by those skilled in the art that, although specific embodiments have been illustrated and described herein for purposes of illustration, various modifications may be made, and equivalents may be substituted, without deviating from the scope of the invention.

For instance, while foregoing examples have been explained with respect to states machines, it will be appreciated that provision may also be made for the observation of bus signals by H/W resources including other gated processing devices.

Additionally, many modifications may be made to adapt a particular situation to the teachings of the present description without departing from the central inventive concept described herein. Furthermore, an embodiment may not include all of the features described above. Therefore, it is intended that the present description be not be limited to the particular embodiments disclosed, but that the invention include all embodiments falling within the scope of the appended claims.

It is stipulated that the reference signs in the claims do not limit the scope of the claims, but are merely inserted to enhance the legibility of the claims.

1. A method of obtaining Memory Access Performance metrics in an electronic system comprising a Data Processing Unit, DPU and a synchronous memory device external to the DPU and coupled to the DPU through a memory bus, the method using mixed software and hardware dedicated resources, wherein at least a hardware part of said dedicated resources is comprised in the memory device.

2. Method according to claim 1, comprising steps of calculating performance metrics based on detected events and sequences of events, an event being defined by a given pattern of values for a set of signals of the memory bus at an active transition of a memory clock, wherein the detection of events, the detection of sequences of events and/or the calculation of metrics are performed by the hardware part of the dedicated resources comprised in the memory.

3. Method according to claim 2, wherein the definition of events and of sequences of events is programmable by software through registers of the hardware part of the dedicated resources comprised in the memory.

4. Method according to claim 2, comprising steps of running diagnosis tasks, each diagnosis task being defined by a start condition, a stop condition, and a given number of associated performance metrics measured during diagnosis which are stored in the hardware part of the dedicated resources comprised in the memory.

5. Method according to claim 5, wherein, after completion of a diagnosis task, the associated performance metrics are accessible by the DPU through the memory bus.

6. A synchronous memory device adapted for use in an electronic system comprising a Data Processing Unit, DPU, and a synchronous memory device external to the DPU and coupled to the DPU through a memory bus, the memory device comprising at least an embedded hardware part of mixed software and hardware resources dedicated to obtaining Memory Access Performance metrics in the system.

7. Memory device according to claim 6, wherein the embedded hardware part of the dedicated resources is adapted for calculating performance metrics based on detected events and sequences of events, an event being defined by a given pattern of values for a set of signals of the memory bus at an active transition of a memory clock.

8. Memory device according to claim 7, wherein the embedded hardware part of the dedicated resources comprises programmable registers adapted for, when programmed by software, defining events and sequences of events.

9. Memory device according to claim 7, wherein the embedded hardware part of the dedicated resources is further adapted for running diagnosis tasks, each diagnosis task being defined by a start condition, a stop condition, and a given number of associated performance metrics measured during diagnosis and stored in the embedded hardware part of the dedicated resources.

10. Memory device according to claim 9, wherein the embedded hardware part of the dedicated resources is further adapted for the associated performance metrics being accessible by the DPU through the memory bus, after completion of a diagnosis task.

11. Computer-readable medium carrying one or more sequences of instructions for performing all the steps of a method according to claim 1 when executed by a processor.

12. Computer program product comprising one or more stored sequences of instructions that are accessible to a processor and which, when executed by the processor, cause the processor to carry out all the steps of a method according to claim 1.

13. Electronic system comprising a Data Processing Unit, DPU, and a synchronous memory device, external to the DPU and coupled to the DPU through a memory bus, according to claim 6.

14. Electronic system according to claim 13 wherein the DPU comprises at least a software part of the resources dedicated to obtaining Memory Access Performance metrics, said software part being adapted for controlling the hardware part of said dedicated resources to obtain the Memory Access Performance metrics through the memory bus.

15. Wireless communication device comprising an electronic system according to claim 13.
